(19) United States
(12) Patent Application Publication
(10) Pub. No.: US 2003/0038020 A1
(43) Pub. Date: Feb. 27, 2003

(54) Switch

(76) Inventors: Ryoichi Taniuchi, Fukui (JP); Takeshi Fujii, Fukui (JP); Toyoshi Fukumura, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 10/224,278

(22) Filed: Aug. 21, 2002

(30) Foreign Application Priority Data
Aug. 24, 2001 (JP) 2001-254319

(51) Int. Cl. H01H 21/00

(52) U.S. Cl. 200/339

(57) ABSTRACT

A switch having good maneuverability is provided. The switch of this invention includes a switch case, a rocker-button unit having a perforation thereon and a rotating shaft, which is located at a side of the rocker button unit and held at the switch case, and a pushing-button unit inserted at the perforation movably and vertically. Besides, the switch includes a slider whose upper surface comes in contact with a lower surface of the pushing-button unit, and the slider is accommodated in the switch case movably and vertically.

### FIELD OF THE INVENTION

The present invention relates to a switch, which is incorporated in a dashboard and the like of a car, changes working of electric devices of the car.

### BACKGROUND OF THE INVENTION

Conventional switches, which are incorporated in a dashboard and the like of a car, correspond to electric devices of the car. FIG. 10 is a partial front view of the dashboard using the conventional switches, and shows ON-OFF switch 1 for a windshield wiper and pushing switch 2 for ejecting cleaning fluid.

ON-OFF switch 1 is a rocker switch for switching from a neutral position to a right or a left position. For example, in FIG. 10, when switch 1 is switched to the right position, the windshield wiper is operated slowly, and when switch 1 is switched to the left position, the windshield wiper is operated fast.

When switch 2 is pushed, the cleaning fluid is ejected, and when switch 2 is released, switch 2 returns to an original position mechanically and ejecting of the cleaning fluid stops.

FIG. 10 shows a part of the dashboard, but an actual dashboard has many switches, e.g., switches for controlling an air-conditioning in the car, locking and unlocking a door key of the car or operating information devices.

The conventional switches incorporated in the dashboard correspond to electric devices of the car, and recent cars have various electric devices, so that many switches are incorporated in the dashboard. As a result, it is difficult for drivers to operate the many switches correctly and promptly.

A switch unifying a pushing switch and a rocker switch is disclosed in utility model laid-open No. S62-53538 and No. S62-53539 to solve the problems discussed above. However, the conventional switches disclosed above can not provide enough click-feeling, and especially, the click-feeling deteriorates after repeated operations.

### SUMMARY OF THE INVENTION

The present invention addresses the problems discussed above, and aims to provide a switch which can be incorporated in a dashboard simply and can be operated promptly. Because the switch has good maneuverability, the switch can prevent a false operation of a driver.

The switch of present invention includes the following elements:

(a) a switch case,

(b) a rocker-button unit having a perforation thereon and a rotating shaft, which is located at a side of the rocker button unit and held at the switch case,

(c) a pushing-button unit inserted at the perforation movably and vertically, and

(d) a slider whose upper surface comes in contact with a lower surface of the pushing-button unit, the slider accommodated in the switch case movably and vertically.

This structure can provide the small switch having functions of a rocker switch and a pushing switch, so that an area for incorporating the switch becomes small.

### BRIEF DESCRIPTION OF THE DRAWINGS

FIG. 1 shows a sectional view of a switch in accordance with a first exemplary embodiment of the present invention.

FIG. 2 shows an exploded perspective view of the switch in accordance with the first embodiment of the invention.

FIG. 3 shows a sectional view of an essential part of the switch in accordance with the first embodiment of the invention.

FIG. 4 shows a sectional view of an essential part of the switch in accordance with the first embodiment of the invention.

FIG. 5 shows a sectional view of an essential part of a switch in accordance with a second exemplary embodiment of the present invention.

FIG. 6 shows a sectional view of an essential part of the switch in accordance with the second embodiment of the invention.

FIG. 7 shows a sectional view of a switch in accordance with a third exemplary embodiment of the present invention.

FIG. 8 shows a perspective view of an essential part of the switch in accordance with the third embodiment of the invention.

FIG. 9 shows a perspective view of an essential part of the switch in accordance with the third embodiment of the invention.

FIG. 10 shows a partial front view of a conventional dashboard.

### DETAILED DESCRIPTION OF PREFERRED EMBODIMENT

A switch of this invention has a perforation on an operating surface of a rocker-button unit, where the perforation is perpendicular to the operating surface, and a pushing-button unit is inserted at the perforation and is movable vertically. The switch is formed by unifying the rocker-button unit and a pushing button unit, thereby having functions of a rocker switch and a pushing switch, so that the switch can be small and an area for incorporating the switch can be small. As a result, the switch can be incorporated in a dashboard simply, prevent a false operation of a driver and be operated promptly because the switch has good maneuverability.

The pushing-button unit of this invention has a dome shape, and has horizontal protrusions of its edge, where the protrusions are used for preventing rotation of the pushing-button unit by touching a guide section of said rocker-button unit. This horizontal protrusions can prevent rotation resulted from repeated operations of the pushing-button unit or vibration of a car, and prevent deterioration of visibility of a display of the pushing-button unit.

An upper surface of the rocker-button unit protrudes from an opening of an upper surface of a box-shaped switch case, and the rocker-button unit is held at a side of the switch case rotatably by using rotating shafts located at its sides. A bottom part of the pushing-button unit comes in contact with an upper part of a slider, which is held in a middle part of the switch case and is movable vertically. Protrusions of a bottom part of the rocker-button unit and a bottom part of a slider come in contact with switch units for operating, where the switch units are disposed on a substrate and under an opening of the switch case.

The switch has a click feeling element which retains a position after operation of the rocker-button unit. The click feeling element is formed of the following elements:

a) protrusions of a bottom part of the rocker-button unit,

b) a bottom part of the switch case, and

c) an elastic member and a head, whose lower surface is arc shaped, located between the protrusions and the bottom part of the switch case.

The switch is formed by unifying the rocker-button unit and a pushing button unit. This structure can provide the small switch having functions of the rocker switch and the pushing switch, so that an area for incorporating the switch becomes small. As a result, the switch can be incorporated in a dashboard simply, prevent a false operation of a driver and be operated promptly because the switch has good maneuverability. In addition to that, this switch can provide the click feeling element easily satisfying demands of the market, for example, desired click-feeling or operation, using this structure.

As mentioned above, the bottom part of the pushing-button unit comes in contact with the upper part of the slider. At the contact section between the pushing-button unit and the slider, the slider has an arc shape whose center is located on a line connected between rotating shafts of the rocker-button unit. At the contact section, the pushing button unit has an arc shape whose diameter is a little larger than a diameter of the arc shape of the slider. In this structure, a lower surface of the arc shape of the pushing-button unit can fit an upper surface of the arc shape of the slider. As a result, when the rocker-button unit works, smooth operation and good click-feeling can be obtained. In addition to that, this switch can obtain the large contact section easily, so that the slider can move up and down smoothly when the pushing-button unit is pushed.

The contact section between the pushing-button unit and the slider can be located at a position above an axis of rotation of the rocker-button unit. When the rocker-button unit moves, an amount of sliding-movement at the contact section between the pushing-button unit and the slider can be small using this structure. As a result, abrasion resulted from repeated operations of the rocker-button unit can be suppressed, and deterioration of click-feeling can be prevented.

In this switch, an opening section can be formed at a center of the slider, and a light emitting member is located at the substrate. As a result, light can be transmitted to the pushing-button unit through the opening section, and a surface of the button can be irradiated.

In addition to that, this switch can have a light guide section at the opening section. Light from the light emitting member is gathered using this structure, and a surface of the pushing-button unit can be irradiated with high efficiency.

First Embodiment

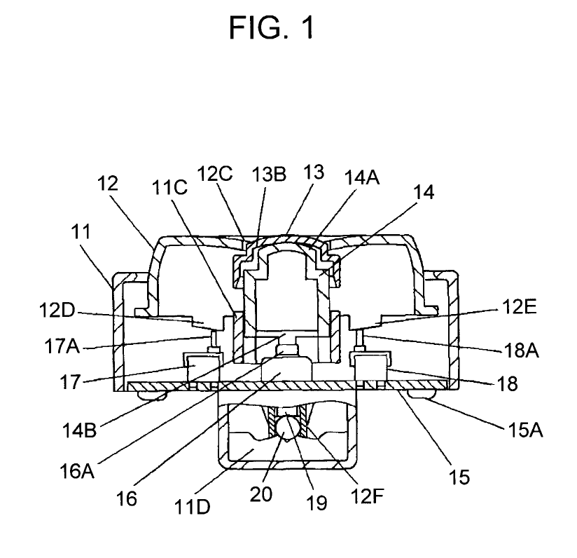

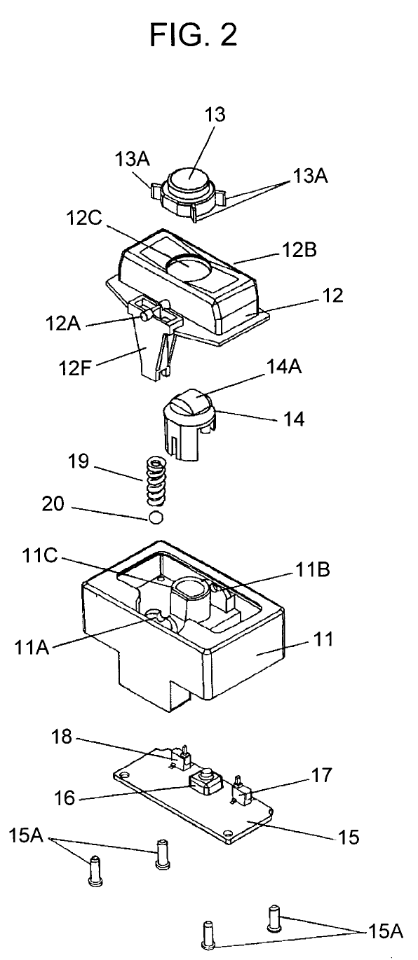

FIG. 1 shows a sectional view of a switch in accordance with the first exemplary embodiment of the present invention. FIG. 2 shows an exploded perspective view of the switch in accordance with the first embodiment of the invention. In FIG. 1 and FIG. 2, switch case 11 has openings on its upper surface and lower surface, and an upper surface of rocker-button unit 12, i.e., a rocker switch, protrudes from the opening of the upper surface of switch case 11.

Rotating shafts 12A and 12B, which are formed at a middle of rocker-button unit 12 in the direction of the length and protrude horizontally from unit 12, and are rotatably mated with bearings 11A and 11B, which are formed at upper positions of walls of switch case 11.

Pushing-button unit 13 is inserted at circular perforation 12C of a center of rocker-button unit 12, where an upper section of pushing-button unit 13, i.e., a pushing switch, is domed. Guide ribs 13A protrude horizontally from a circumference of unit 13, and used for preventing rotation by touching guide sections (not shown) formed at an inner side of rocker-button unit 12. As a result, pushing-button unit 13 is prevented from rotating.

Semi-cylindrical slider 14, which is held in guide wall 11C incorporated in switch case 11 and is movable vertically, is disposed under pushing-button unit 13. Upper part 14A of slider 14 comes in contact with bottom part 13B of pushing-button unit 13, where bottom part 13B has an arc shape.

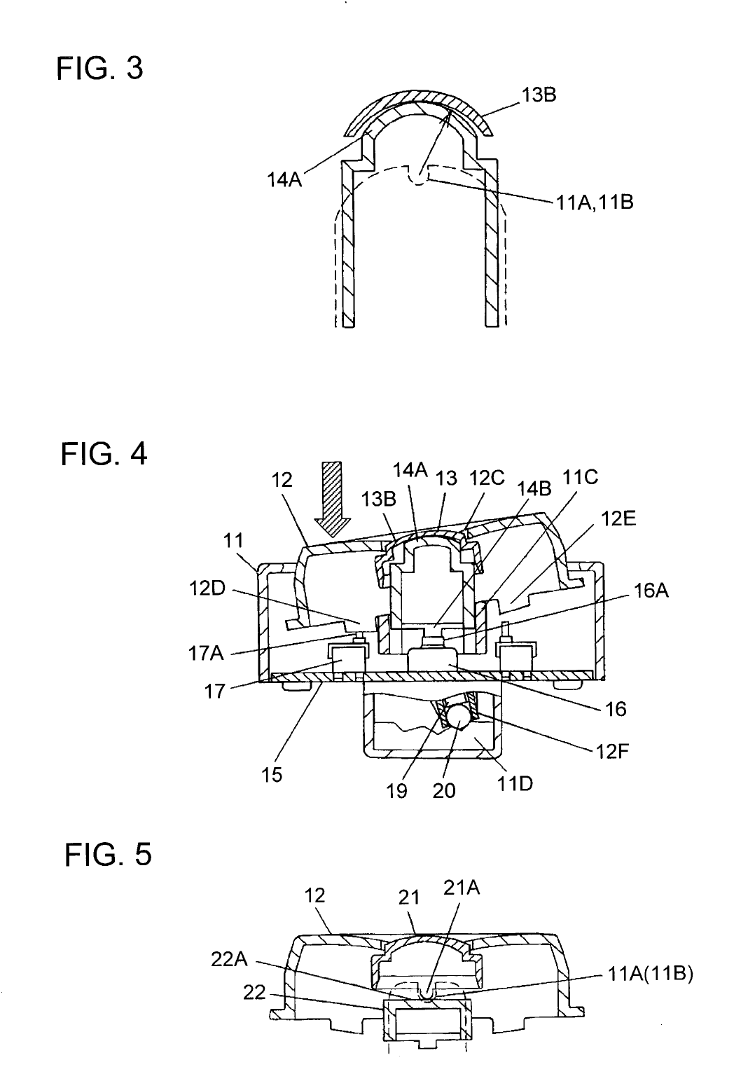

FIG. 3 shows a sectional view of an essential part of the switch of this invention. As shown in FIG. 3, upper part 14A of slider 14 has an arc shape whose center is located on a line connected between a center of bearing 11A and a center of bearing 11B, which hold rotating shafts 12A and 12B of rocker-button unit 12. Bottom part 13B of pushing-button unit 13 has the arc shape whose diameter is a little larger than a diameter of the arc shape of upper part 14A of slider 14.

Printed circuit board 15, which is fixed with screws 15A for closing the opening of switch case 11, is disposed under switch case 11. Printed circuit board 15 is used for transmitting ON/OFF signals of switch units 16, 17 and 18, which are disposed on board 15, to an external circuit (not shown).

At switch units 16, 17 and 18, when pushing switches 16A, 17A and 18A are pushed, the switch becomes an ON state, and when pressure for switches 16A, 17A and 18A are removed, the switch returns to an OFF state mechanically by restoring force. At the ON state, an upper part of switch 16A of switch unit 16 comes in contact with bottom part 14B of slider 14, and an upper part of switches 17A, 18A of switch units 17, 18 comes in contact with bottom parts of downward protrusions 12D, 12E. Protrusions 12D and 12E are formed respectively on either side of a line connected between shaft 12A and shaft 12B of rocker-button unit 12.

A click-feeling element is described hereinafter. The click-feeling element is formed of the following elements:

(a) spring 19 formed of a coil spring,

(b) ball 20 energised under spring 19, and

(c) zigzag section 11D formed on an inner bottom of switch case 11.

Spring 19 and ball 20 are accommodated in cylinder 12F protruded downward from one of the longer side of rocker-button unit 12, and ball 20 comes in contact with zigzag section 11D formed on the inner bottom of switch case 11.

An operation of the switch of this invention is described hereinafter with reference to FIG. 4.

For example, when a left side of rocker-button unit 12 is pushed (shown at an arrow-mark in FIG. 4), the left side of rocker-button unit 12, which is held at shafts 12A and 12B, moves downward. Then a bottom part of downward protrusion 12D of a left side of rocker-button unit 12 pushes pushing switch 17A of switch unit 17. As a result, switch unit 17 becomes an ON state, and an ON signal is transmitted to the external circuit via printed circuit board 15.

When rocker-button unit 12 is operated, the click feeling element mentioned above is also operated. When the left side of rocker-button unit 12 moves downward, cylinder 12F, which is protruded downward from one side of rocker-button unit 12, moves in the right direction. As a result, ball 20 accommodated in cylinder 12F moves along zigzag section 11D formed on the inner bottom of switch case 11.

Ball 20 is energised against zigzag section 11D by spring 19. After ball 20 climbs over a convex section of zigzag section 11D, ball 20 moves swiftly to a concave section (the right direction in FIG. 4) where energising force of spring 19 decreases. At that time, click-feeling can be obtained by working of rocker-button unit 12. When ball 20 reaches the concave section of zigzag section 11D, working of rocker-button unit 12 stops.

In this embodiment, the coil spring is used as the elastic member, however, a flat spring can be used depending on a combination of the head and the elastic member, and elastomer having rubber elasticity can be also used as an elastic member. Ball 20 is used as the head located between spring 19 and zigzag section 11D for obtaining click-feeling, however, the head is not limited to a ball shape. A head, whose lower surface has an arc shape, e.g., a bullet shape or a semi-cylindrical shape, can be used as the head for this invention.

An operation of pushing-button unit 13 is described hereinafter. In FIG. 1, when pushing-button unit 13 is pushed, slider 14, which comes in contact with bottom part 13B of pushing-button unit 13, moves downward along guide wall 11C formed in switch case 11. Then slider 14 pushes pushing switch 16A of switch unit 16, which comes in contact with bottom part 14B of slider 14, and switch unit 16 becomes an ON state. As a result, an ON signal is transmitted to the external circuit via printed circuit board 15.

When pressure for pushing-button unit 13 is removed, slider 14 moves upward by restoring force of switch unit 16 mechanically, and pushing-button unit 13 returns to an original state as shown in FIG. 1.

Under the condition that rocker-button unit 12 is operated, when pushing-button unit 13 is pushed, switch unit 16 can be also an ON sate.

When rocker-button unit 12 is pushed (shown at an arrow-mark in FIG. 4), pushing-button unit 13 is guided in an inner wall of circular perforation 12C of rocker-button unit 12, and tilts in the same direction of rocker-button unit 12. Bottom part 13B of pushing-button unit 13 comes in contact with upper part 14A of slider 14, and unit 13 moves on upper part 14A along the arc whose center is located at the same position of rotating of rocker-button unit 12. As a result, pushing-button unit 13 does not adversely affect the click-feeling of rocker-button unit 12, and moves smoothly.

As shown in FIG. 4, on the condition that rocker-button unit 12 is operated, when pushing-button unit 13 is pushed, slider 14 moves downward along guide wall 11C, and pushes pushing switch 16A, so that switch unit 16 becomes an ON state. At that time, though pushing-button unit 13 is tilted, upper part 14A, which comes in contact with bottom part 13B, and bottom part 13B have arc shapes and can fit each other, so that this structure can obtain a large contact section, and contact condition becomes stable. As a result, pressure to pushing-button unit 13 is transmitted to slider 14 certainly, and slider 14 can be pressed downward and smoothly along guide wall 11C.

In this invention, pushing-button unit 13 is inserted at circular perforation 12C of the center of rocker-button unit 12, and unit 13 and unit 12 are integrated with each other. Switch units 16, 17 and 18 are worked by operating rocker-button unit 12 and pushing-button unit 13. This structure can provide the small switch having functions of the rocker switch and the pushing switch, so that an area for incorporating the switch can be small. As a result, the switch can be incorporated in a dashboard simply, prevent a false operation of a driver and be operated promptly because the switch has good maneuverability.

Pushing-button unit 13, which has a dome shape, has guide ribs 13A protruded horizontally from a circumference of unit 13, so that guide ribs 13A are regulated by guide sections of rocker-button unit 12. As a result, guide ribs 13A can prevent rotation resulted from repeated operations of pushing-button unit 13 or vibration of a car, and prevent deterioration of visibility of a display by using pushing-button unit 13.

The switch of this invention includes ball 20 moving with rocker-button unit 12, spring 19 energising ball 20 and zigzag section 11D of switch case 11. Using the structure mentioned above, this switch can provide the click feeling element satisfying demands of the market, for example, desired click-feeling and an automatic-restoring system whose stop position is only a neutral position.

Second Embodiment

The second embodiment is demonstrated hereinafter. The elements similar to those described in the first embodiment have the same reference marks, and the descriptions of those elements are omitted here.

FIG. 5 shows a sectional view of an essential part of a switch in accordance with the second exemplary embodiment of the present invention. Pushing-button unit 21 has hemispherical fulcrum section 21A protruded downward from its bottom.

A height of fulcrum section 21A of pushing-button unit 21 is the same as a height of bearings 11A, 11B of switch case 11, namely a height of fulcrum of rocker-button unit 12. The tip of fulcrum section 21A comes in contact with upper surface 22A of slider 22, where upper surface 22A has a plane shape.

An operation of the switch of this invention is described hereinafter.

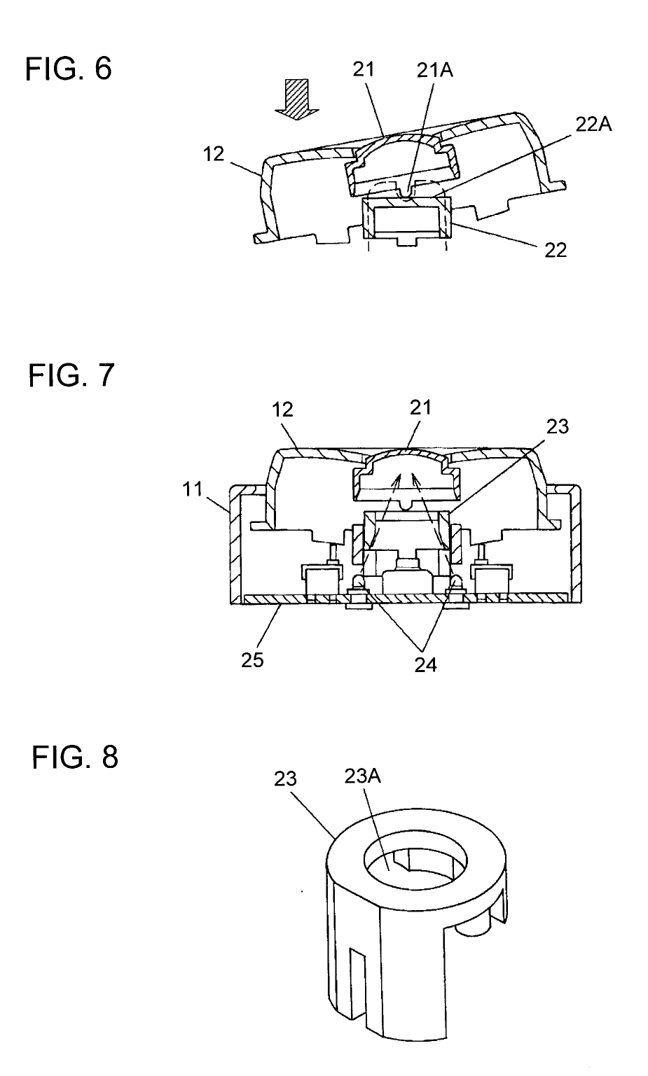

FIG. 6 shows a sectional view of an essential part of the switch in accordance with the second embodiment of the invention. When a left side of rocker-button unit 12 is pushed (shown at an arrow-mark in FIG. 6), pushing-button unit 21 is guided in an inner wall of circular perforation 12C of rocker-button unit 12, and tilts in the same direction of rocker-button unit 12.

Pushing-button unit 21 can rotate about fulcrum section 21A, which comes in contact with upper surface 22A of slider 22. At that time, the height of fulcrum section 21A is the same height of fulcrum of rocker-button unit 12. In other words, the position of fulcrum section 21A is located at a position on the line between rotating shafts 12A and 12B. As a result, pushing-button unit 21 does not adversely affect the click-feeling of rocker-button unit 12, and moves smoothly. In FIG. 6, when pushing-button unit 21 is pushed, pressure to pushing-button unit 21 is transmitted to slider 22 certainly, so that slider 22 can move smoothly.

According to this invention, an amount of sliding-movement of fulcrum section 21A of pushing-button unit 21 on upper surface 22A of slider 22 can be small. As a result, abrasion resulted from repeated operations of rocker-button unit 12 can be suppressed, and deterioration of click-feeling can be prevented.

Third Embodiment

The third embodiment is demonstrated hereinafter. The elements similar to those described in the first embodiment or the second embodiment have the same reference marks, and the descriptions of those elements are omitted here.

As shown in FIG. 7, a switch in accordance with the third embodiment of the present invention includes switch case 11, rocker-button unit 12, pushing-button unit 21 and slider 23. As shown in FIG. 8, opening section 23A is formed on a center of an upper surface of slider 23.

Light emitting diode 24, which is used as a light emitting member, is located at printed circuit board 25, and electric power is supplied from an external circuit to diode 24. Functions for switching of the switch are the same as those described in the first embodiment and the second embodiment.

As shown at broken lines in FIG. 7, using the switch of this invention, light can be guided from light emitting diode 24 to pushing-button unit 21 via opening section 23A of slider 23. When high light-transmissive material is used as pushing-button unit 21 and a surface of button 21 is irradiated, high visibility can be obtained even if the switch is located in the darkness.

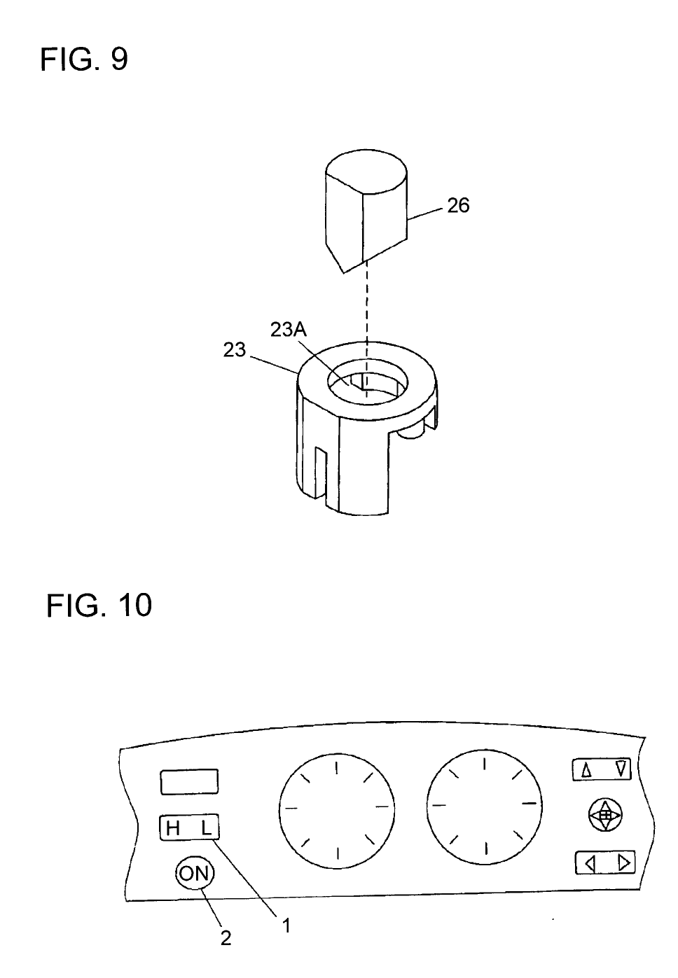

As shown in FIG. 9, when light guide section 26, which is made of transparent resin and the like, is disposed in opening section 23A of slider 23, light from light emitting diode 24 is gathered, and the surface of the pushing-button unit 21 can be irradiated with high efficiency.

What is claimed is:

1. A switch comprising:
(a) a switch case,
(b) a rocker-button unit having a perforation thereon and a rotating shaft, which is located at a side of said rocker button unit and held at said switch case,
(c) a pushing-button unit inserted at the perforation movably and vertically, and
(d) a slider whose upper surface comes in contact with a lower surface of said pushing-button unit, said slider accommodated in said switch case movably and vertically.

2. The switch of claim 1,
wherein said slider is held in a guide wall which is incorporated in said switch case.

3. The switch of claim 1,
wherein an upper part of said pushing-button unit has a dome shape.

4. The switch of claim 1,
wherein a lower surface of said pushing button unit has a first arc shape, said an upper surface of slider has a second arc shape whose center is located on an axis of rotation of said rocker-button unit, and a diameter of the first arc shape is a little larger than a diameter of the second arc shape.

5. The switch of claim 1 further comprising:
a substrate, which has switch units, disposed under an opening of said switch case,
wherein said rocker-button unit has a downward protrusion, and an upper part of the switch units come in contact with the downward protrusion of said rocker-button unit and a bottom part of said slider.

6. The switch of claim 1 further comprising:
a click-feeling element which retains a position after an operation of said rocker-button unit.

7. The switch of claim 6,
wherein said click-feeling element includes a zigzag section formed on an inner bottom of said switch case, an elastic member and a head whose lower surface is arc shaped.

8. The switch of claim 7,
wherein said elastic member and said head are accommodated in a cylinder protruded downward from said rocker-button unit,
wherein said click-feeling element is formed by disposing the head between said zigzag section and said elastic member.

9. The switch of claim 1,
wherein a protrusion is formed at a circumference of said pushing-button unit, and used for preventing rotation by touching a guide section of said rocker-button unit.

10. The switch of claim 1,
wherein a hemispherical fulcrum section is protruded downward from a center of a bottom of said pushing-button unit, an upper surface of said slider has a plane shape, and a position where said fulcrum section comes in contact with the upper surface of said slider is located on an axis of rotation of said rocker-button unit.

11. The switch of claim 1,
wherein said pushing-button unit is light transmissive, an opening section is formed on an upper surface of said slider and a light emitting member is disposed on a substrate,
wherein said pushing-button unit is irradiated with light from the light emitting member.

12. The switch of claim 11
wherein a light guide section is disposed at the opening section of said slider.
